(19) United States
(12) Patent Application Publication
(10) Pub. No.: US 2007/0221727 A1
(43) Pub. Date: Sep. 27, 2007

(54) System and Method For Determining Product Shelf Life

(75) Inventor: Dan Reznik, New York, NY (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., PRINCETON, NJ (US)

(21) Appl. No.: 11/687,104

(22) Filed: Mar. 16, 2007

Related U.S. Application Data
(60) Provisional application No. 60/784,280, filed on Mar. 21, 2006.

(51) Int. Cl. G06K 15/00

(52) U.S. Cl. 235/383

(57) ABSTRACT

A method of determining whether a product is within a useable shelf life includes obtaining a first set of data associated with the product, wherein the first set of data includes a first timestamp and a first assessed quality, obtaining a second set of data associated with the product, wherein the second set of data includes a second timestamp and environmental history data, computing a second assessed quality using the first and second timestamps and the environmental history data, and determining whether the product is within the useable shelf life using the second assessed quality.

### CROSS-REFERENCE TO RELATED PATENT APPLICATION

This application claims the benefit of U.S. Provisional Application Ser. No. 60/784,280 (Attorney Docket No. 2006E05597US), filed Mar. 21, 2006 and entitled “An RFID- and Sensor-Based System and Method for Estimating the Shelf Life or Expiration Date of Shipped Products,” the content of which is herein incorporated by reference in its entirety.

### BACKGROUND OF THE INVENTION

1. Technical Field

The present disclosure relates to supply chain logistics and inventory management and, more particularly, to systems and methods for estimating the shelf life or expiration date of products.

2. Discussion of Related Art

Many products such as medicine, foods and other perishable items that flow through the supply chains and markets at global and regional levels bear expiration dates. For example, the expiration date stamped on packaged perishable foods provides consumers with information about the last date that the food should be eaten. This information may read: “use by” or “do not use after”.

Some products such as canned goods have a “best before” date. Although products that have a “best before” date may be safely consumed after the date has passed, the product is likely to have deteriorated in flavor, appearance, texture and/or nutrition. If left unused too long, food that is not sterilized will ultimately spoil due to the growth of microorganisms and may become dangerous to eat. Food poisoning may result from the ingestion of spoiled food and can be fatal.

Accurate determination of the shelf life of a product can be a central part of optimizing consumer safety and satisfaction. Shelf life is different from expiration date. Shelf life can be defined as the length of time a product may be stored without becoming unsuitable for use or consumption. A food product that has passed its shelf life may still be safe, but optimal quality and freshness is no longer guaranteed. Medicines have a defined shelf life and must be used before their expiration date to ensure effectiveness and safety.

Shelf life testing may be conducted to determine the length of time that a product will maintain its safety and quality. Product quality can be mathematically modeled around a single parameter, such as the concentration of a chemical compound, a microbiological index or a physical parameter Under some circumstances, product shelf life can be critical to health. Drugs, for example, begin to deteriorate after manufacture. The drug manufacturer, in calculating the expiration date, factors in this rate of deterioration. Medicine taken after the expiration date may have changed in potency or contain harmful breakdown products that form as the drug deteriorates.

Shelf life may vary according to storage conditions. A product's shelf life may be affected by any combination of light, oxygen, heat, humidity or mechanical stresses. For example, the shelf life of foods may depend upon the food itself, packaging type and method, temperature and humidity. A product manufacturer may specify the useful shelf life for predicted worst-case storage conditions. In some cases, products are discarded prematurely because of conservative shelf life estimation by the manufacturer.

Many food products such as dairy products, meats, poultry, eggs, and fresh fruits and vegetables spoil rapidly if not stored at proper temperatures It has been recommended that dairy products be stored at refrigerated temperatures between 34° F. and 38° F., meats between 33° F. and 36° F., eggs 33° F. to 37° F., and fresh fruits and vegetables should be stored between 35° F. and 40° F. The shelf life of liquid milk stored below 40° F. may range from eight to twenty days depending upon the date of manufacture and storage conditions in the grocer's shelf. Canned vegetables can be stored in a cool, dry area between 50° F. and 70° F. for up to one year. It has been recommended that frozen foods be stored below 32° F. in moisture-proof, gas-impermeable plastic or freezer wrap. Frozen foods may be stored beyond the recommended storage time but quality may be diminished.

Food that is temperature abused may spoil rapidly. Foods may be spoiled without a detectable off-odor, off-flavor or off-color The “when in doubt throw it out” maxim is commonly applied to foods, but may result in the unnecessary disposal and waste of food.

Recent outbreaks of animal diseases that pose a serious risk to human health, such as bird flu and mad cow disease, have raised worldwide interest in identifying and monitoring livestock. New identification programs have been set up by governments with radio-frequency identification (RFID) technology in those monitoring systems.

RFID is an automatic identification method that relies on storing and remotely retrieving data using transponders or RFID tags, generally known as tags. Tags consist of silicon chips and antennae that can transmit data to a wireless receiver. RFID tags come in a wide range of physical forms, shapes, sizes and protective housings. RFID tags can be attached to or incorporated into livestock or products for identification purposes.

There is a need for products to be packaged and shipped safely from their point of manufacture and delivered efficiently to warehouses and marketplaces. However, inefficient practices in the distribution system may make it difficult or costly for companies to sustain the quality and safety of their shipped products. A need exists for systems and methods for determining useable shelf life of a product using RFID technologies.

### SUMMARY OF THE INVENTION

According to an exemplary embodiment of the present invention, a method of determining whether a product is within a useable shelf life includes obtaining a first set of data associated with the product, wherein the first set of data includes a first timestamp and a first assessed quality, obtaining a second set of data associated with the product, wherein the second set of data includes a second timestamp and environmental history data, computing a second assessed quality using the first and second timestamps and the environmental history data, and determining whether the product is within the useable shelf life using the second assessed quality.

According to an exemplary embodiment of the present invention, a system for determining whether a product is within a useable shelf life includes a memory device for storing a program, a processor in communication with the memory device, the processor operative with the program to obtain a first set of data associated with the product, wherein the first set of data includes a first timestamp, a first assessed quality and first environmental history data, obtain a second set of data associated with the product, wherein the second set of data includes a second timestamp and second environmental history data, compute a second assessed quality using the first and second timestamps and the first and second environmental history data, and determine whether the product is within the useable shelf life using the second assessed quality

According to an exemplary embodiment of the present invention, a method for accepting or rejecting a product based on a quality measurement, includes placing the product on a conveyor for moving the product over a predetermined path, obtaining a first set of data associated with the product, wherein the first set of data includes a first timestamp, a first assessed quality and first environmental history data, determining whether a radio-frequency identification (RFID) tag has been read while operating the conveyor to move the product over a portion of the predetermined path, when it is determined that an RFID tag has been read, obtaining a second set of data associated with the product, wherein the second set of data includes a second timestamp, a sensor identifier and second environmental history data, and computing a second assessed quality using the first and second timestamps and the first and second environmental history data, using the second assessed quality and the sensor identifier to determine whether to stop the conveyor; and if the conveyor is stopped, determining whether to accept or reject the product based on the second assessed quality.

According to an exemplary embodiment of the present invention, a system for accepting or rejecting a product based on a quality measurement includes a conveyor for moving the product over a predetermined path, the conveyor including a drive motor for driving the conveyor, a memory device for storing a program, at least one radio-frequency identification (RFID) reader for reading RFID tags, the RFID reader in communication with the memory device and a processor in communication with the memory device. The processor is operative with the program to control the drive motor to drive the conveyor to move the product over a predetermined path, obtain a first set of data associated with the product in the memory device, wherein the first set of data includes a first timestamp, a first assessed quality and first environmental history data, determine whether an RFID tag has been read, when it is determined that an RFID tag has been read, obtain a second set of data associated with the product in the memory device, wherein the second set of data includes a second timestamp, a sensor identifier and second environmental history data, and compute a second assessed quality using the first and second timestamp and the first and second environmental history, use the second assessed quality and the sensor identifier to determine whether to stop the conveyor, and if the conveyor is stopped, determine whether to accept or reject the product based on the second assessed quality.

### BRIEF DESCRIPTION OF THE DRAWINGS

The present invention will become more apparent to those of ordinary skill in the art when descriptions of exemplary embodiments thereof are read with reference to the accompanying drawings.

FIG. 1 is a graph for illustrating an exponential decay curve representing the quality and expiration date as a function of average shipping temperature.

FIG. 2 is side view of an example of a system for determining whether a product is within a useable shelf life, according to an exemplary embodiment of the present invention.

FIG. 3 is plan view of an example of system for determining whether a product is within a useable shelf life, according to an exemplary embodiment of the present invention.

FIG. 4 is a flowchart showing a method for determining whether a product is within a useable shelf life, according to an exemplary embodiment of the present invention.

FIG. 5 is a flowchart showing a method for determining whether to accept or reject a product based on a quality measurement, according to an exemplary embodiment of the present invention.

FIG. 6 is a flowchart showing a method for determining whether to accept or reject a product based on a quality measurement, according to an exemplary embodiment of the present invention.

FIG. 7 illustrates a computer system for implementing a method for determining whether a product is within a useable shelf life, according to an exemplary embodiment of the present invention.

### DESCRIPTION OF EXEMPLARY EMBODIMENTS

Hereinafter, exemplary embodiments of the present invention will be described in detail with reference to the accompanying drawings.

In the case of a food product with a predetermined shelf life, the shelf life may be based on an expected temperature range during shipment. For example, the expected temperature range may be 1° to 10° C. However, if during shipment the temperature is maintained at 5° C., the useable shelf life may be extended, for example, based on a temperature/quality model. Food, medicines and other perishable items may deteriorate more quickly if the item is maintained at a higher-than-expected temperature during shipment. In such cases, the shelf life can be decreased and the product may spoil before the expiration date.

The quality of expiration-dated products may degrade as a function of the shipment distance and/or shipping conditions, such as for example, temperature or humidity A distributor, retailer or consumer provided with the knowledge of a product's temperature history may be able to make use of the product for a longer period, and concerns about possible consumer harm may be removed and the unnecessary disposal of unspoiled goods may be avoided.

In an exemplary embodiment of the present invention, a system for determining whether a product is within a useable shelf life is configured with storage media and the capability to record environmental history data for the product. For example, environmental history data may be entered or programmed into radio-frequency identification (RFID) tags. Environmental history data may be stored on storage media, such as for example, computer hard disk drives, CD-ROM drives and removable media such as CDs, DVDs, Universal Serial Bus (USB) drives, floppy disks, diskettes and tapes, or a combination thereof.

The environmental history data may include, for example, a trace-back of the route a product takes to market, minimum and maximum temperatures, average temperature, humidity, altitude, and maximum acceleration. An automated data collection infrastructure based on RFID data, sensor data, or combination thereof, may be used. For example, suppliers, manufacturers, distributors, and retailers may record and/or share product movement data using RFID tags. In an exemplary embodiment of the present invention, a system for determining whether a product is within a useable shelf life includes readers for reading or interrogating the tags and/or sensors and means of communicating the data to a host computer or information management system.

RFID systems range in frequency and application Three frequency ranges are generally distinguished for RFID systems: Low/High/Ultra-High Frequency (LF/HF/UHF) tags are designed for short, mid and long reading ranges. Three carrier frequencies that are representative of the low, high and ultra-high ranges are 125 kHz, 12 MHz and 2.45 GHz. The higher the frequency, the more narrow the reading zone from reader to tag, and the more opaque do fluids and metals become. A good compromise for food applications, rich in water, is the HF range, e.g., 13.56 MHz tags.

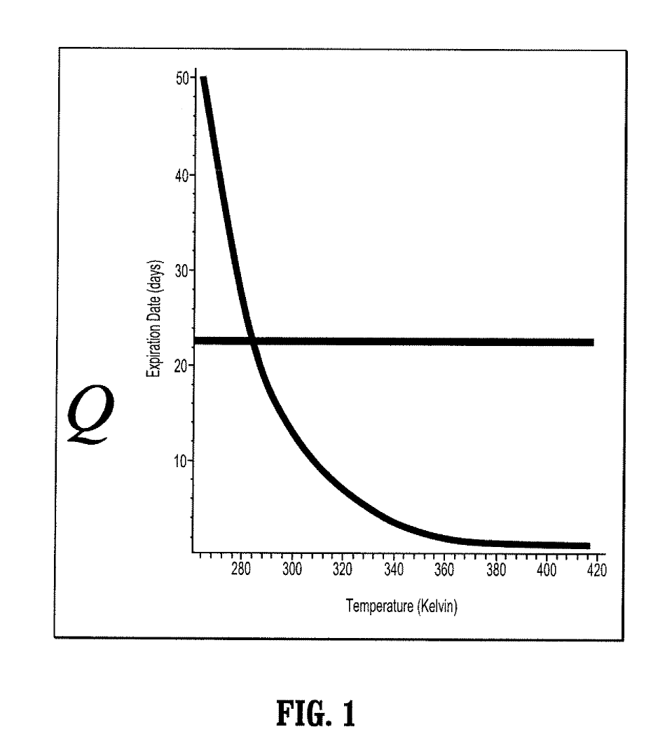

In an exemplary embodiment of the present invention, a temperature-based model is used for determining whether a product is within a useable shelf life. FIG. 1 is a graph for illustrating an exponential decay of expiration date as a function of average shipping temperature. Referring to FIG. 1, the horizontal line depicts an example expiration date as assigned to a product by its manufacturer. In this example, the manufacturer has fixed the expiration date at twenty-three days.

However, an a-priori limit on the period of time in which a product is safe for consumption, for example, as fixed by an expiration date on a product container/label, can overshoot or undershoot the actual time, depending on the environmental conditions (e.g., as measured at various time points) during shipping.

Whether a product is still suitable for consumption or use at a point in time after its date of manufacture can be evaluated as a function of temperature history. As shown in FIG. 1, shelf life can be modeled as an exponentially-decaying function of the average temperature that the product was exposed to during its shipping history. In a system for determining whether a product is within a useable shelf life, according to an exemplary embodiment of the present invention, environmental conditions are measured at a plurality of time points during shipment, and the product quality Q may be assessed over multiple time points.

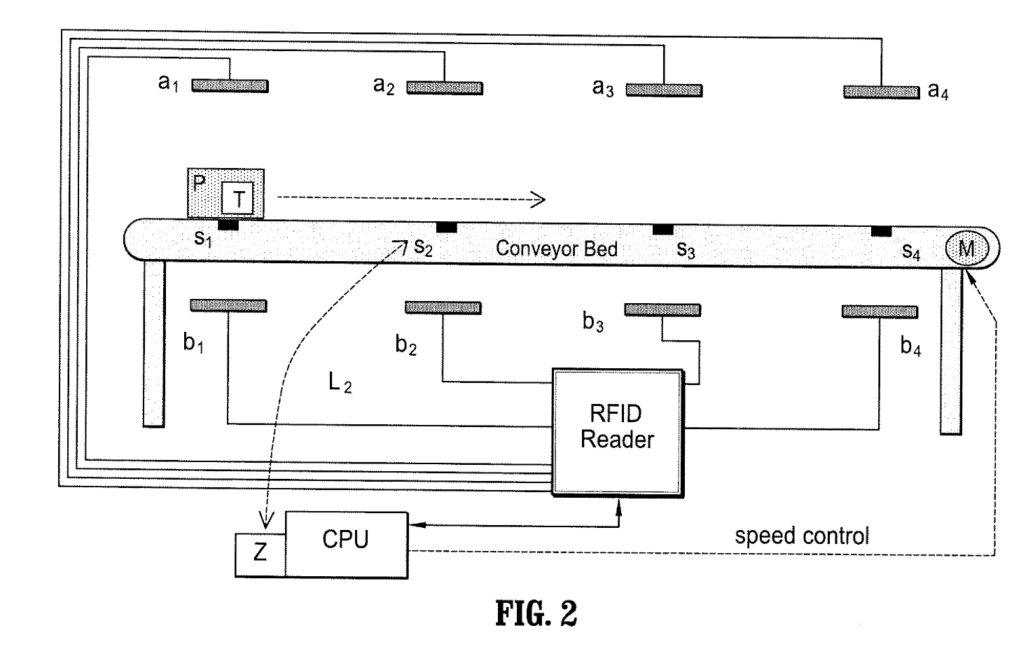

FIG. 2 is plan view of a system for determining whether a product is within a useable shelf life, according to an exemplary embodiment of the present invention. Referring to FIG. 2, a single conveyor includes a left end, which may represent a shipping zone (e.g., in a food manufacturing plant), and a right end, which may represent a receiving zone. Low/High/Ultra-High Frequency (LF/HF/UHF) RFID tags and readers may be used. In an exemplary embodiment of the present invention, a system for determining whether a product is within a useable shelf life includes UHF-type RFID tags and readers. The readers can be configured to operate with a plurality of antennas that both transmit and receive, or a plurality of antenna pairs where one antenna transmits and the other one receives. One or more readers can be configured to operate with a single antenna.

HF tags may be used when fluids are present in the product P. UHF also can be made to work reliably when fluids are present, for example, under adequate power and tag placement (e.g., line of sight). The UHF RFID readers may drive four antenna pairs. As shown in FIG. 2, four antenna pairs (aᵢ, bᵢ), i=1 . . . 4, may be arranged at substantially equal intervals along the conveyor. All of the antenna pairs may be driven by a single RFID reader, which may be coupled to a CPU. It is to be understood that various numbers of RFID readers may be used to drive any number of antenna pairs.

In an example scenario, a product P carrying an RFID tag Tis placed at the shipping end of the conveyor. The RFID tag T may provide a unique identifier R, which may be a numeric or alphanumeric string that is stored in the RFID tag. The conveyor causes the product P to move from the shipping end to the receiving end. The conveyor bed is driven by a conveyor drive motor M. The conveyor's speed may be adapted to support various rates of throughput. Operations of the drive motor M may be controllable by a CPU.

Sensor modules Sᵢ, i=1 . . . 4, (e.g., capable of measuring temperature, humidity, vibration, etc.) are mounted near each antenna pair (aᵢ, bᵢ), in a way that does not obstruct the flow of product P. As shown in FIG. 2, the sensors modules Sᵢ may be mounted near the edge of the conveyor bed. The sensors modules Sᵢ may be linked to an interface module Z for communication with a CPU. For example, a given sensor S₂ may communicate to a CPU via the interface module Z using a wireless link L₂.

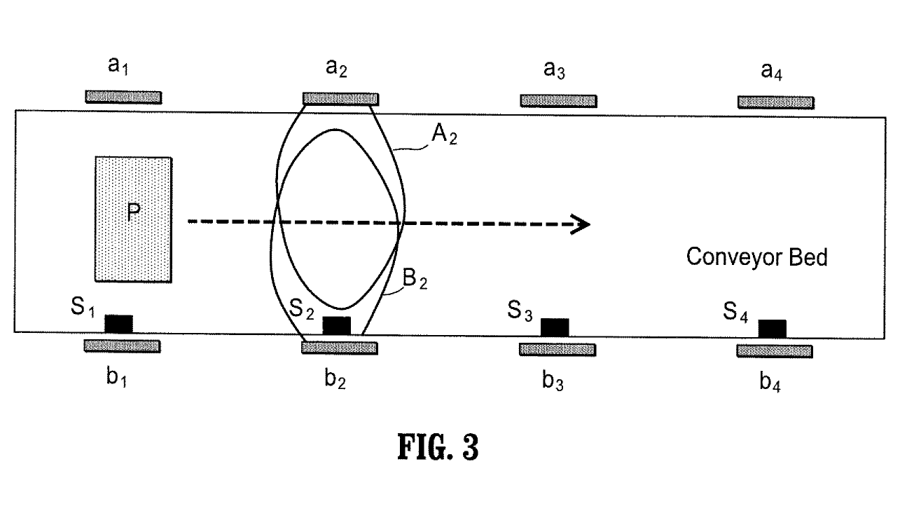

FIG. 3 is top view of a system for determining whether a product is within a useable shelf life, according to an exemplary embodiment of the present invention. In FIG. 3, electrical wiring and components such as RFID readers and CPU are omitted in the interests of simplicity. Product P on the conveyor bed moves in the direction of the arrow in FIG. 3, for example, towards the receiving end. Antenna pairs are disposed along both sides of the conveyor. Each antenna pair may be configured such that their respective irradiation/reading zones encompass a small volume on a portion of the conveyor adjacent to the antenna pair. For example, a small volume may be one that substantially encompasses a surface of the product P as it passes through the reading zone.

The level of available power is generally determinative of the range that can be achieved in an RFID system. For example, range may determined by the power available at the reader to communicate with the tag(s), the power available within a tag to respond, and the environmental conditions and structures. The power and sensitivity of an antenna pair (a₂, b₂) may be adapted to confine their active zones to local zones A₂ and B₂, respectively. This local zone characteristic may be readily achieved for LF- and HF-type RFID tags and readers, but can also be achieved for UHF-type RFID tags and readers, for example, by reducing transmit power (e.g., down to a level at which the absorption by fluids does not preclude reliable reads).

Although not shown as such in FIG. 3, the sensors modules Sᵢ can be mounted above the conveyor bed or under the conveyor bed. The locations of the sensors modules Sᵢ may be fixed or adjustable. For example, the sensors modules Sᵢ may be located in positions as close to the product P flow as possible (or practical) without obstructing the passageway. In a large scale supply chain, sensors could be collocated at major portals and checkpoints of said supply chain (e.g., doorways, entries/exits, storage compartments, shipping/staging areas, truck/airplane beds, etc). The supply chain environmental variables may be sampled with various granularities to assess product quality.

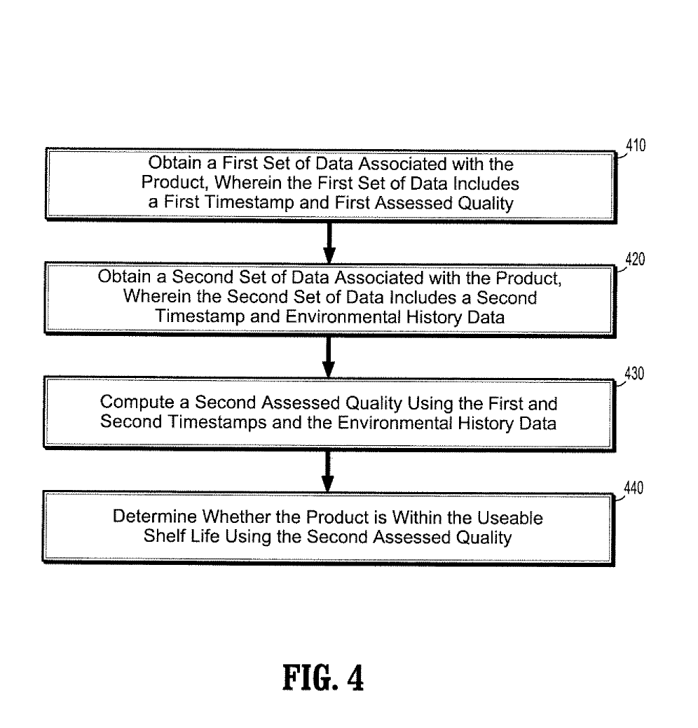

FIG. 4 is a flowchart showing a method for determining whether a product is within a useable shelf life, according to an exemplary embodiment of the present invention. Referring to FIG. 4, in block 410, obtain a first set of data associated with the product, wherein the first set of data includes a first timestamp and a first assessed quality.

The first timestamp may include date and/or time information, such as the date of manufacture, the date and time of shipment, etc. The first assessed quality may be obtained from a table and/or the manufacturer of the product. The first assessed quality may be expressed as a percentage, for example, in the range of 95% to 99%, or 90% to 100%, or 90% to 110%.

Although not shown as such in FIG. 4, the first set of data may include a product identifier. The product identifier may comprise an RFID tag, a bar code, or a contact-based identifier. Examples of contact-based identifiers include contact-based smart-cards and magnetic-cards. An RFID tag may include a unique identifier, such as a numeric or alphanumeric string that is stored in an RFID tag for uniquely identifying the product. The first set of data may include first environmental history data. The first environmental history data may include, for example, a trace-back of the route, minimum and maximum temperatures, average temperature, humidity, altitude, and maximum acceleration.

The first set of data may be stored in an RFID tag. The first set of data may be stored on storage media, such as for example, computer hard disk drives, CD-ROM drives and removable media such as CDs, DVDs, Universal Serial Bus (USB) drives, floppy disks, diskettes and tapes, or a combination thereof.

In block 420, obtain a second set of data associated with the product, wherein the second set of data includes a second timestamp and environmental history data. For example, the second set of data may be obtained by reading an RFID tag, a bar code, or a contact-based identifier. The first timestamp may include the current date and time information. The sensor identifier may be a unique code associated with a sensor and a location. The second environmental history data may include temperature, humidity, altitude, acceleration, lighting or any other data relevant to the quality calculation.

In an exemplary embodiment of the present invention, obtaining the second set of data comprises reading a product identifier and at least one sensor output. The sensor output may include, but is not limited to, temperature, acceleration, humidity, and/or distance traveled. The product identifier may be an RFID tag, a bar code, or a contact-based identifier. For example, the product identifier may be attached to or incorporated into the product, product packaging, and/or a label affixed to the product or the product packaging.

In block 430, compute a second assessed quality using the first and second timestamps and the first and second environmental history data. A temperature-based model, humidity model and/or environmental model may be used to compute the second assessed quality. For example, the temperature-based model may be based on an exponentially-decaying function of the average temperature at which the product was stored during its shipping history. The second assessed quality may be expressed by Equation 1.

$$\frac{\partial Q}{\partial t} = - {k}_{1} {e}^{[ \frac{{E}_{a}}{{R}_{g} t ( t )} ]} {Q}^{n} , \qquad ( 1 )$$

where Eₐ is the activation energy k₁ is the Arrhenius constant, n is the order of the reaction, T is temperature, Q is product quality, and t is time. Using Equation 1, the useable shelf life, for example, in terms of days as shown in FIG. 1, can be calculated as an exponentially-decaying function of the average temperature at which a product was stored.

A humidity model and other environmental models can be defined in a similar exponential nature and such models may be combined (e.g., linearly) to assess quality. In an exemplary embodiment of the present invention, the second assessed quality is computed using the first and second timestamps and first and second environmental history data.

In block 440, determine whether the product is within the useable shelf life using the second assessed quality. This may include determining whether the second assessed quality is greater than a predetermined threshold. For example, if assessed quality ranges from 0 to 1, Q>0.75 could be chosen as the acceptable threshold.

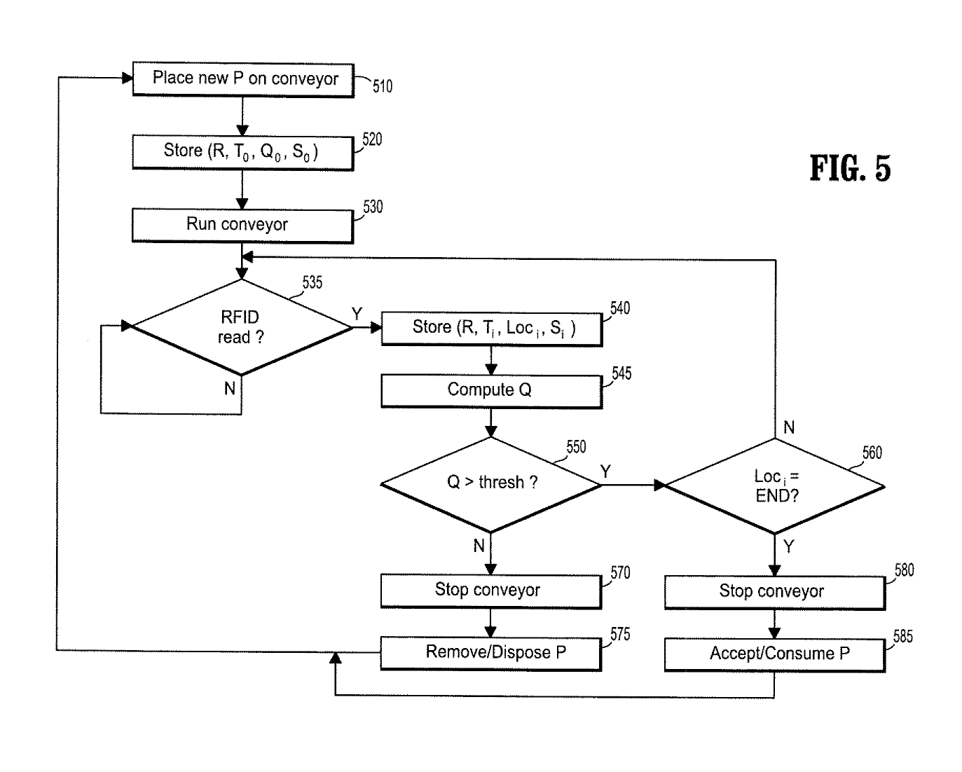

FIG. 5 is a flowchart showing a method for determining whether to accept or reject a product based on its measured quality, according to an exemplary embodiment of the present invention. Referring to FIG. 5, in block 510, a selected product P is placed on a conveyor, for example, at a start position. The start position may correspond to a shipping area.

In block 520, information such as a package identifier R, a current timestamp T₀, quality Q₀, sensor measurements S₀ is recorded. The package identifier R may be a numeric or alphanumeric string that is stored in an RFID tag, a bar code, or a contact-based identifier The product information (R, T₀, Q₀, S₀) may be stored in a user memory, hard disk, or on a read-write portion the RFID tag.

The quality Q₀ may be obtained from a table and/or a manufacturer of the product. The sensor measurements S₀ may include temperature, acceleration, humidity, and/or distance traveled.

In block 530, a CPU controls a conveyor drive motor M to run the conveyor at a desired speed. In block 535, it is determined whether an RFID read event has occurred coming from one of the antenna pairs.

In block 540, product information (R, Ti, Locᵢ, Sᵢ) is recorded, containing the package identifier R, a new timestamp, the location of the sensor, and a new sensor measurement.

In block 545, a new quality value Q can be computed, for example, using Equation 1. In block 550, determine whether Q lies below a threshold of acceptability. If Q lies below a threshold of acceptability, then the conveyor is stopped (block 570). For example, the CPU instructs the drive motor M to stop driving the conveyor. Product P is removed (block 575) from the flow, e.g., manually or through an automatic divert.

If Q is above the threshold of acceptability, then if the location of the antenna pair (and sensor) coincides with that of the receiving zone (block 560), the conveyor is stopped (block 580), and product P is accepted (block 585), e.g., mimicking delivery or direct consumption. The method may be repeated by returning to block 510.

If product P is still not at the receiving zone (block 560), the method returns to waiting for a new RFID event (block 535), e.g., from the next antenna pair.

The product information may be collected by a personal computer (PC), e.g., transmitted by the RFID reader to the PC. In a decentralized implementation, RFID tags may be used as a data carrier. The route and environmental history data, which may be encrypted, may be recorded on the writeable area of the tags.

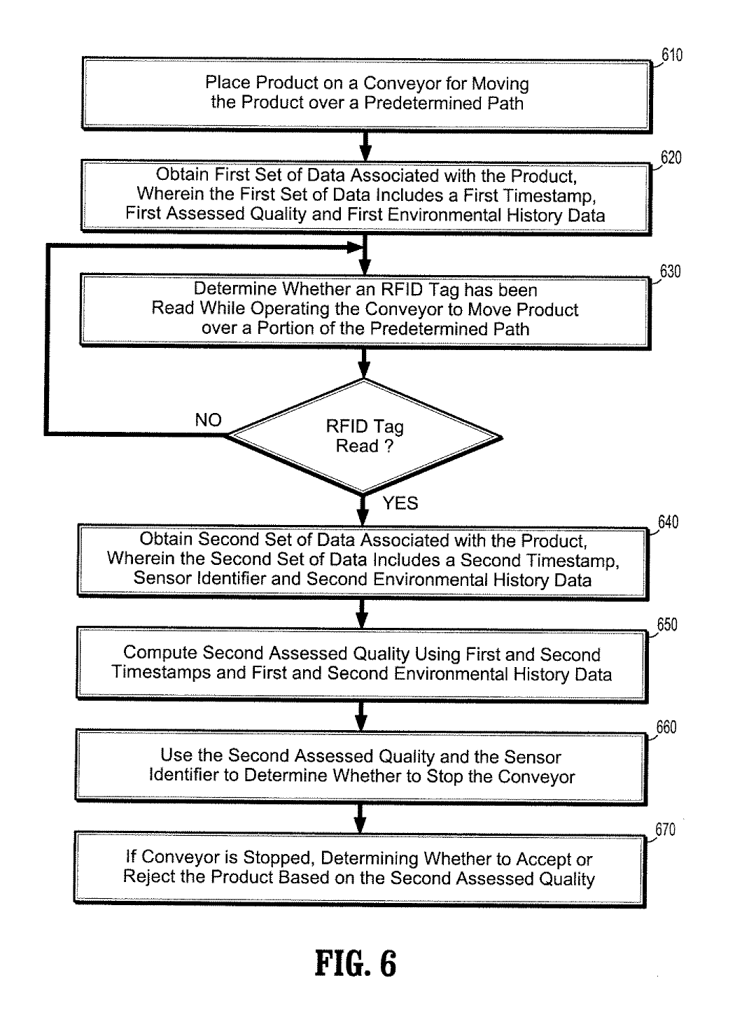

FIG. 6 is a flowchart showing a method for determining whether to accept or reject a product based on a quality measurement, according to an exemplary embodiment of the present invention. Referring to FIG. 6, in block 610, place the product P on a conveyor for moving the product over a predetermined path.

In block 620, obtain a first set of data associated with the product, wherein the first set of data includes a first timestamp, a first assessed quality and first environmental history data. The first timestamp may include date and time information. The first assessed quality may be obtained from a table and/or the manufacturer of the product. For example, the first assessed quality may range from 95% to 99%, or 90% to 100%, or 90% to 110%, etc. The first set of data may be stored in a memory device or storage media, such as random access memory (RAM), read only memory (ROM), disk drive, tape drive, or a combination thereof. The first set of data may further include a package identifier. The product identifier may be an RFID tag, a bar code, or a contact-based identifier, such as for example, a contact-based smart-card or a magnetic-card.

In block 630, determine whether an RFID tag has been read while operating the conveyor to move the product over a portion of the predetermined path. The RFID tag may be an LF, HF or UHF tag. The RFID tag may be attached to or incorporated into the product, product packaging, and/or a label affixed to the product or the product packaging.

When it is determined that an RFID tag has been read, in block 640, obtain a second set of data associated with the product, wherein the second set of data includes a second timestamp, a sensor identifier and second environmental history data. The sensor identifier may be an RFID tag, barcode or a contact-based identifier, e.g., a contact-based smart-card or a magnetic-card. The sensor may be an RFID reader, a barcode scanner, or a contact-based identity reader, such as a contact-based smart-card reader or a magnetic-card reader. The second environmental history data may include temperature, humidity, altitude, acceleration, lighting or other data relevant to the quality calculation.

In block 650, compute a second assessed quality using the first and second timestamps and the first and second environmental history data. The second assessed quality may be computed using a temperature-based model, humidity model and/or environmental model that are modeled using an exponential decay function. For example, a temperature-based model may be based on an exponentially-decaying function of the average temperature at which the product was stored during its shipping history. The second assessed quality may be expressed by Equation 1.

In block 660, use the second assessed quality and the sensor identifier to determine whether to stop the conveyor. For example, if it is determined that the second assessed quality is less than or equal to a predetermined threshold, the conveyor is stopped. For example, if the second assessed quality is in a range of 0 to 1, the conveyor may be stopped if the quality is below 0.75. In the case where the sensor identifier corresponds to a predetermined sensor, for example, the last sensor before the receiving zone, the conveyor can be stopped, for example, after a predetermined time. The predetermined time may vary according to the conveyor's speed.

In block 670, if the conveyor is stopped, determine whether to accept or reject the product based on the second assessed quality. For example, if the second assessed quality is in a range of 0 to 1, the product may be rejected if the second assessed quality is below a predetermined threshold of 0.75. It will be appreciated that the predetermined threshold may depend on the nature of the product P. For example, in the case where the product P is a medicine, a higher threshold may be chosen for the predetermined threshold, e.g., 0.90 or 0.95.

It is to be understood that exemplary embodiments of the present invention may be implemented in various forms of hardware, software, firmware, special purpose processors, or a combination thereof. For example, exemplary embodiments of the present invention may be implemented in software as an application program tangibly embodied on a program storage device. The application program may be uploaded to, and executed by, a machine comprising any suitable architecture.

In a centralized processing environment, a CPU gathers the sensory data and generates the commands to the conveyor drive motor M. In a supply-chain scale implementation, data gathering and processing can take place via a distributed set of CPUs interconnected via a network such as the Ethernet.

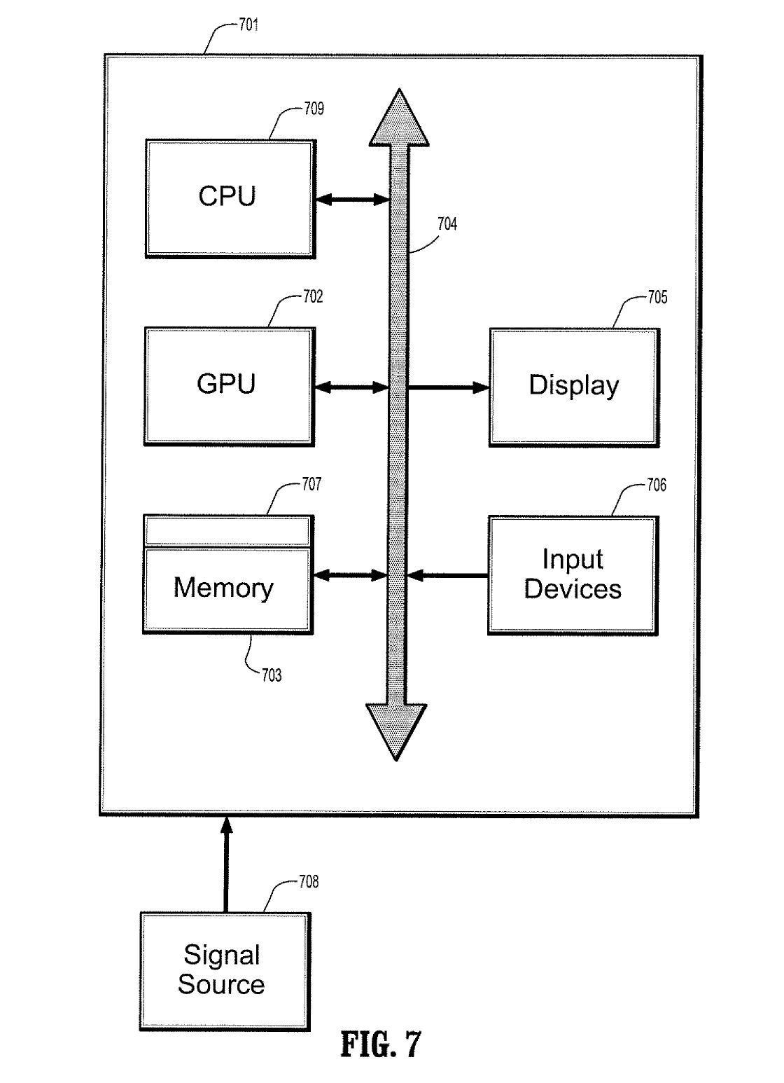

Referring to FIG. 7, according to an exemplary embodiment of the present disclosure, a computer system 701 for implementing a method of determining whether a product is within a useable shelf life can comprise, inter alia, a central processing unit (CPU) 709, a memory 703 and an input/output (I/O) interface 704. The computer system 701 may include a graphics processing unit (GPU) 702. The computer system 701 is generally coupled through the I/O interface 704 to a display 705 and various input devices 706 such as a mouse and keyboard. The support circuits can include circuits such as cache, power supplies, clock circuits, and a communications bus. The memory 703 can include random access memory (RAM), read only memory (ROM), disk drive, tape drive, etc., or a combination thereof. An exemplary embodiment of the present invention can be implemented as a routine 707 that is stored in memory 703 and executed by the CPU 709 to process the signal from the signal source 708. As such, the computer system 701 is a general purpose computer system that becomes a specific purpose computer system when executing the routine 707 of the present invention.

The computer platform 701 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

In an exemplary embodiment of the present invention, a system for determining whether a product is within a useable shelf life comprises a memory device 703 for storing a program, and a processor 709 in communication with the memory device 703. The processor 709 is operative with the program to obtain a first set of data associated with the product P, wherein the first set of data includes a first timestamp, a first assessed quality and first environmental history data, and to obtain a second set of data associated with the product, wherein the second set of data includes a second timestamp and second environmental history data. For example, obtaining the second set of data may include reading a product identifier and at least one sensor output. The sensor output may include, but is not limited to, temperature, acceleration, humidity, and/or distance traveled. The product identifier may be an RFID tag (e.g., an LF, HF or UHF tag), a bar code, or a contact-based identifier.

The first and second timestamps and the first assessed quality incorporate the same information as elements of an exemplary embodiment of the present invention described in connection with FIG. 4, and further descriptions will be omitted. The first environmental history data may include, for example, a trace-back of the route, minimum and maximum temperatures, average temperature, humidity, altitude, and maximum acceleration. The second environmental history data may include temperature, humidity, altitude, acceleration, lighting or other data relevant to the quality calculation.

The processor 709 may be further operative with the program to compute a second assessed quality using the first and second timestamps and the first and second environmental history data, and determine whether the product is within the useable shelf life using the second assessed quality. This may include determining whether the second assessed quality is greater than a predetermined threshold. For example, if assessed quality ranges from 0% to 100%, the predetermined threshold could be chosen to be 75%.

In an exemplary embodiment of the present invention, a system for accepting or rejecting a product based on a quality measurement comprises a memory device 703 for storing a program, and a processor 709 in communication with the memory device 703. The processor 709 is operative with the program to control the drive motor to drive the conveyor to move the product over a predetermined path, obtain a first set of data associated with the product, wherein the first set of data includes a first timestamp, a first assessed quality and first environmental history data, determine whether an RFID tag has been read, and when it is determined that an RFID tag has been read, obtain a second set of data associated with the product in the memory device, wherein the second set of data includes a second timestamp, a sensor identifier and second environmental history data.

The first set of data and/or the second set of data may include a package identifier, such as for example, a numeric or alphanumeric string that is stored in an RFID tag, a bar code, or a contact-based identifier (e.g., a contact-based smart-card or a magnetic-card).

The processor 709 may be further operative with the program to compute a second assessed quality using the first and second timestamp and the first and second environmental history. The second assessed quality may be computed using at least one of a temperature-based model, humidity model or environmental model that is modeled using an exponential decay function.

The processor 709 may be further operative with the program to use the second assessed quality and the sensor identifier to determine whether to stop the conveyor. The conveyor may be stopped when it is determined that the second assessed quality is less than or equal to a predetermined threshold. For example, if the second assessed quality is in a range of 0% to 100%, the conveyor may be stopped if the second assessed quality is below 75%. The predetermined threshold may depend on the nature of the product P. For example, in the case where the product P is a medicine, a higher threshold may be chosen for the predetermined threshold, such as 0.90%, 95% and so forth. If the conveyor is stopped, the processor 709 may be further operative with the program to determine whether to accept or reject the product based on the second assessed quality.

It is to be further understood that, because some of the constituent system components and method steps depicted in the accompanying figures may be implemented in software, the actual connections between the system components (or the process steps) may differ depending upon the manner in which the present invention is programmed. Given the teachings of exemplary embodiments of the present invention provided herein, one of ordinary skill in the related art will be able to contemplate these and similar implementations or configurations of the present invention.

Although exemplary embodiments of the present invention have been described in detail with reference to the accompanying drawings for the purpose of illustration, it is to be understood that the inventive processes and apparatus are not to be construed as limited thereby. It will be readily apparent to one of ordinary skill in the art that various modifications to the foregoing exemplary embodiments can be made without departing from the scope of the invention as defined by the appended claims, with equivalents of the claims to be included therein.

What is claimed is:

1. A method of determining whether a product is within a useable shelf life, comprising:
obtaining a first set of data associated with the product, wherein the first set of data includes a first timestamp and a first assessed quality;
obtaining a second set of data associated with the product, wherein the second set of data includes a second timestamp and environmental history data;
computing a second assessed quality using the first and second timestamps and the environmental history data; and
determining whether the product is within the useable shelf life using the second assessed quality.

2. The method of claim 1, wherein the step of obtaining the second set of data comprises reading at least one of an RFID tag, a bar code, or a contact-based identifier.

3. The method of claim 2, wherein the step of obtaining the second set of data further comprises reading at least one sensor output.

4. The method of claim 1, wherein the second assessed quality is computed using at least one of a temperature-based model, humidity model or environmental model that is modeled using an exponential decay function.

5. The method of claim 4, wherein the temperature-based model is based on an exponentially-decaying function of the average temperature at which the product was stored during its shipping history.

6. A system for determining whether a product is within a useable shelf life, comprising:
a memory device for storing a program;
a processor in communication with the memory device, the processor operative with the program to:
obtain a first set of data associated with the product, wherein the first set of data includes a first timestamp, a first assessed quality and first environmental history data;
obtain a second set of data associated with the product, wherein the second set of data includes a second timestamp and second environmental history data;
compute a second assessed quality using the first and second timestamps and the first and second environmental history data; and
determine whether the product is within the useable shelf life using the second assessed quality.

7. The system of claim 6, wherein the step of obtaining the second set of data comprises reading a product identifier and at least one sensor output.

8. The system of claim 7, wherein the product identifier is an RFID tag, a bar code, or a contact-based identifier.

9. The system of claim 6, wherein the second assessed quality is computed using at least one of a temperature-based model, humidity model or environmental model that is modeled using an exponential decay function.

10. The system of claim 9, wherein the temperature-based model is based on an exponentially-decaying function of the average temperature at which the product was stored during its shipping history.

11. A method for accepting or rejecting a product based on a quality measurement, comprising:
placing the product on a conveyor for moving the product over a predetermined path;
obtaining a first set of data associated with the product, wherein the first set of data includes a package identifier, a first timestamp, a first assessed quality and first environmental history data;
determining whether a radio-frequency identification (RFID) tag has been read while operating the conveyor to move the product over a portion of the predetermined path;
when it is determined that an RFID tag has been read,
obtaining a second set of data associated with the product, wherein the second set of data includes the package identifier, a second timestamp, a sensor identifier and second environmental history data, and
computing a second assessed quality using the first and second timestamps and the first and second environmental history data;
using the second assessed quality and the sensor identifier to determine whether to stop the conveyor; and
if the conveyor is stopped, determining whether to accept or reject the product based on the second assessed quality.

12. The method of claim 11, wherein the package identifier is a numeric or alphanumeric string that is stored in an RFID tag, a bar code, or a contact-based identifier.

13. The method of claim 11, wherein the sensor identifier is an RFID tag, a barcode, or a contact-based identification.

14. The method of claim 11, wherein the second assessed quality is computed using at least one of a temperature-based model, humidity model or environmental model that is modeled using an exponential decay function.

15. The method of claim 11, further comprising determining whether the second assessed quality is greater than a predetermined threshold.

16. The method of claim 15, wherein the second assessed quality is in a range of 0 to 1, and wherein the predetermined threshold is 0.75.

17. The method of claim 16, wherein, when it is determined that the second assessed quality is less than or equal to the predetermined threshold, stopping the conveyor.

18. A system for accepting or rejecting a product based on a quality measurement, comprising:
a conveyor for moving the product over a predetermined path, the conveyor including a drive motor for driving the conveyor;
a memory device for storing a program;
at least one radio-frequency identification (RFID) reader for reading RFID tags, the RFID reader in communication with the memory device;
a processor in communication with the memory device, the processor operative with the program to:
control the drive motor to drive the conveyor to move the product over a predetermined path;
obtain a first set of data associated with the product in the memory device, wherein the first set of data includes a first timestamp, a first assessed quality and first environmental history data;
determine whether an RFID tag has been read;
when it is determined that an RFID tag has been read,
obtain a second set of data associated with the product in the memory device, wherein the second set of data includes a second timestamp, a sensor identifier and second environmental history data, and
compute a second assessed quality using the first and second timestamp and the first and second environmental history;
use the second assessed quality and the sensor identifier to determine whether to stop the conveyor; and
if the conveyor is stopped, determine whether to accept or reject the product based on the second assessed quality.

19. The system of claim 18, wherein the second assessed quality is computed using at least one of a temperature-based model, humidity model or environmental model that is modeled using an exponential decay function.

20. The system of claim 19, wherein the temperature-based model is based on an exponentially-decaying function of the average temperature at which the product was stored during its shipping history.
